(19) United States
(12) Patent Application Publication
(10) Pub. No.: US 2008/0252534 A1
(43) Pub. Date: Oct. 16, 2008

(54) Antenna Device and Mobile Radio Apparatus Using the Same

(76) Inventors: Motoyuki Okayama, Osaka (JP); Naoki Yuda, Osaka (JP); Yoshitaka Nagatomi, Nara (JP); Hiroaki Ozeki, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/570,818

(22) PCT Filed: Aug. 24, 2005
(86) PCT No.: PCT/JP2005/015313

§ 371 Date: Mar. 6, 2006

(30) Foreign Application Priority Data
Sep. 10, 2004 (JP) 2004-263592

(51) Int. Cl. H01Q 1/24; H01Q 3/24

(52) U.S. Cl. 343/702; 343/876

(57) ABSTRACT

An antenna device and a mobile radio apparatus using the same antenna device are disclosed. The antenna device includes a ground plate of which short side has a length “a”, a first and a second antenna elements, and a switching circuit. The switching circuit selects whether the first and the second antenna elements are used as a balanced type of antenna or the first antenna is used as an unbalanced type of antenna and the second antenna element is left as a passive element. Assume that wavelength λ₁ corresponds to the fundamental frequency of the antenna elements, and wavelength λ₂ corresponds to the max. frequency in a usable frequency band, and the antenna elements have electrical length θ which is set at λ₁/4. Assume that the first antenna element has physical length L1 smaller than electrical length θ, and the second antenna element has physical length L2. The sum of L1 and L2 is shorter than the short side length “a”, and a half of “a” is smaller than λ₂/4.

### TECHNICAL FIELD

The present invention relates to antenna devices to be used in mobile radio apparatuses such as mobile phones, and also relates to mobile radio apparatuses using the same antenna devices.

### BACKGROUND ART

Mobile radio apparatuses recently have gone multifunctional, e.g. a mobile phone has an additional function of receiving television signals for its user to watch the signals on the liquid crystal display built-in the mobile phone.

This additional radio function to mobile radio apparatuses must avoid enlarging the entire size as much as possible. The antenna device necessary for this additional radio function must be thus inevitably small in size, so that a balanced or unbalanced type of antenna device has been solely and unavoidably employed. A conventional antenna device related to the present invention is disclosed in, e.g. Unexamined Japanese Patent Publication No. 2001-251131.

However, the foregoing balanced or unbalanced type of antenna device solely used comprises antenna elements which have a predetermined directivity, so that the mobile radio apparatus must be oriented in response to its receiving status in order to obtain a stable receiving sensitivity. The apparatus thus can be inconvenient for users in this respect.

### DISCLOSURE OF INVENTION

The present invention aims to decrease directivity in radiation characteristic of an antenna device, and increase convenience of mobile radio apparatuses employing this antenna device.

The antenna device of the present invention comprises the following elements: a ground plate; first and second antenna elements, and a switching circuit. The first and the second antenna elements are placed in parallel with one side of the ground plate. The switching circuit selects one of the following two ways: connecting the first antenna element to the second antenna element via a first feeder section for forming a balanced type of antenna, or connecting the first antenna element to the ground plate via a second feeder section for forming an unbalanced type of antenna while the second antenna element is left as no fed. The ground plate shapes like a rectangle.

Assume that the one side of the ground plate, where the first and second antenna elements are placed, is a short side of which length is “a”, and a long side has length “b”. The first and second antenna elements have their own established fundamental frequency, and assume that the wavelength corresponding to that fundamental frequency is λ₁. The two antenna elements have their applied frequency band, and assume that the wavelength corresponding to the highest frequency thereof is λ₂. Assume that the electric length of the first and second antenna elements is θ, and the physical lengths thereof are L1 for the first antenna element and L2 for the second antenna element. The antenna device of the present invention satisfies the following formulas:

θ=λᵢ/4, L1<θ, (L1+L2)≦a, a/2<λ₂/4

Satisfying the foregoing formulas allows the directivities in the radiation characteristic to form a characteristic expressed in two “8” letters orthogonal to each other, so that the two “8” letters are switched appropriately for decreasing the directivity effectively.

The mobile radio apparatus of the present invention comprises the following elements: a first antenna device identical to the foregoing antenna device, a first signal processor; a second antenna device; and a second signal processor. The first signal processor receives/outputs a signal form/to the first antenna device. The second antenna device uses a frequency band different from the first antenna device, and the second signal processor receives/outputs a signal from/to the first antenna device. The foregoing structure allows a mobile radio apparatus having various dimensional constraints to employ the antenna device that can form the directivities in the radiation characteristic, and the directivity can be expressed in two “8” letters orthogonal to each other. The apparatus thus can obtain stable receiving sensitivity free from changes in orientation of the apparatus depending on its receiving status.

### BRIEF DESCRIPTION OF THE DRAWINGS

FIG. 1 shows a block diagram illustrating a structure of a mobile radio apparatus in accordance with an embodiment of the present invention.

FIG. 2 shows a schematic diagram illustrating an antenna device in accordance with an embodiment of the present invention.

FIG. 3 shows an operating status of the antenna device in accordance with the embodiment and used as a balanced type of antenna.

FIG. 4 shows a directivity characteristic of the balanced type of antenna shown in FIG. 3.

FIG. 5 shows an operating status of the antenna device used in accordance with the embodiment and used as an unbalanced type of antenna.

FIG. 6 shows a directivity characteristic of the unbalanced type of antenna shown in FIG. 5.

FIG. 7 shows a directivity characteristic of the antenna element shown in FIG. 5, which element has a length longer than a short side of a ground plate.

FIG. 8 shows the directivity characteristics shown in FIGS. 4 and 6 superimposed.

FIG. 9 shows a block diagram illustrating an operation of a switch controlling signal of the antenna device in accordance with the embodiment.

FIG. 10 shows an operation of Ex-OR operator which outputs a switch controlling signal in accordance with the embodiment.

FIG. 11 shows an operation of switch controlling in accordance with the embodiment.

FIG. 12 shows a block diagram illustrating an operation of another switch controlling signal of the antenna device in accordance with the embodiment.

FIG. 13 shows an operation of JK flip-flop which outputs a switch controlling signal in accordance with the embodiment.

FIG. 14 shows a block diagram illustrating an operation of still another switch controlling signal of the antenna device in accordance with the embodiment.

FIG. 15 shows a flowchart illustrating an operation of the switch controlling signal shown in FIG. 14.

### DESCRIPTION OF REFERENCE MARK

3 processor block
8, 12 antenna device
10 receiving circuit block
11 transmitting circuit block
13 tuner block
14 ground plate
15, 16 antenna element 17, 18 inductor element (reactance element)
20 bypass conductor
21, 22 switching element
23 switching circuit
24, 25 feeder section
29 signal detector
37 BER detector
45 level detector

### DETAILED DESCRIPTION OF PREFERRED EMBODIMENT

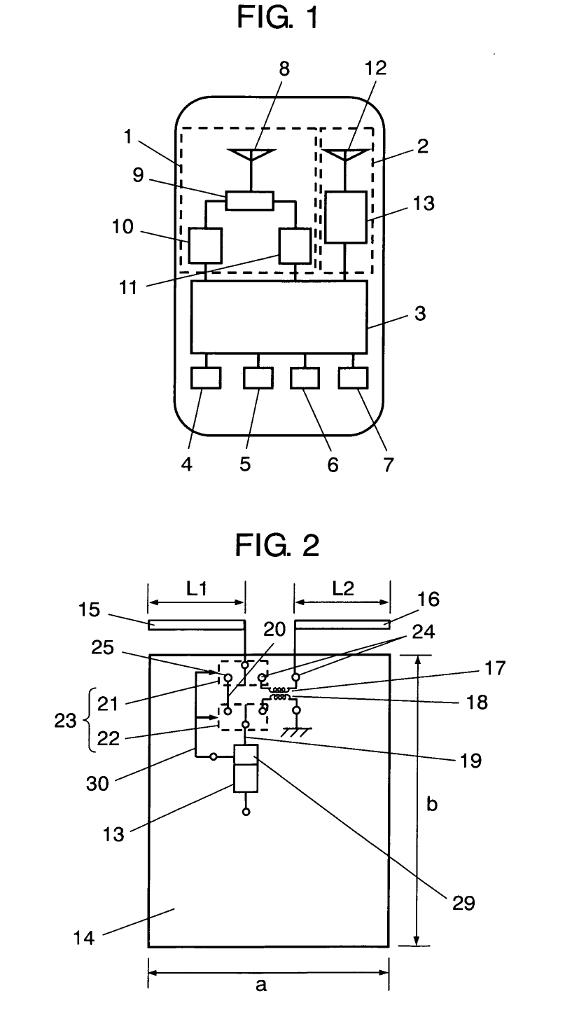

An exemplary embodiment of the present invention is demonstrated hereinafter with reference to the accompanying drawings. FIG. 1 shows a block diagram illustrating a mobile phone having a television function (TV), this mobile phone is an example of a mobile radio apparatus in accordance with an embodiment of the present invention. In FIG. 1, the mobile radio apparatus comprises telephone block 1, TV block 2, processor block 3, speaker 4, microphone 5, keypad 6, and monitor 7.

TV block 2 includes antenna device 12 which is a first antenna device for receiving TV signals, and tuner block 13 working as a first signal processor and placed at a rear stage of antenna device 12.

Telephone block 1 includes antenna device 8, duplexer 9, receiving circuit block 10, and transmitting circuit block 11. Antenna device 8 works as a second antenna device which receives and transmits a reception signal and a transmission signal. Duplexer 9 is connected to antenna device 8 and branches the reception signal as well as the transmission signal. Receiving circuit block 10 is placed at a rear stage of the receiving side of duplexer 9 and processes the reception signals in a high-frequency area. Transmitting circuit block 11 is placed at a rear stage of the transmitting side of duplexer 9 and processes the transmission signals in a high-frequency area. Duplexer 9, receiving circuit block 10 and transmitting circuit block 11 correspond to a second signal processor.

In the mobile phone with a TV, i.e. the mobile radio apparatus in accordance with this embodiment, antenna device 12 receiving TV signals has the structure shown in FIG. 2, which is a schematic diagram illustrating an antenna device in accordance with an embodiment of the present invention. As shown in FIG. 2, the antenna device comprises ground plate 14, antenna elements 15, 16, inductor elements 17, 18, switching circuit 23 including switching elements 21, 22, tuner block 13, and signal detector 29.

Ground plate 14 is a ground conductor placed in a housing of the mobile phone and shapes like a rectangle from a macroscopic standpoint. Antenna elements 15, 16 are placed in parallel with one side of ground plate 14. Inductor element 17 is a kind of reactance elements. Two antenna elements 15, 16 are coupled together via inductor element 17, thereby forming a balanced type of antenna. Inductor element 18 is placed on ground plate 14 side, and coupled with inductor element 17, thereby forming a balun which converts a balanced type of signal received by the balanced type of antenna into an unbalanced type of signal.

The balun is used here for converting the balanced type of signals into the unbalanced type of signals; however, a general circuit employing a transformer or a phase shifter, although they are not shown in the drawings, can be diverted for this purpose. Switching circuit 23 including switching elements 21, 22 switches the balanced type of antenna to/from the unbalanced type of antenna. Tuner block 13 works as the first signal processor and processes a signal switched and supplied by switching circuit 23. Signal detector 29 detects a signal supplied from the balanced or the unbalanced type of antenna.

A first end of inductor element 18 is used as output path 19 that supplies a reception signal to tuner block 13 placed at the rear stage thereof, and a second end is coupled to ground plate 14. Single pole dual throw (SPDT) type of switching element 21 is disposed at an end of inductance element 17. Switching element 21 selectively connects antenna element 15 to one of inductor element 17 or bypass conductor 20 which connects an end of antenna element 15 to output path 19.

SPDT type of switching element 22 is disposed at an end of inductor element 18. Switching element 22 selectively connects output path 19 to one of inductor element 18 or bypass conductor 20. Switching elements 21, 22 form switching circuit 23, so that two antenna elements 15, 16 can be used as two kinds of antennas, namely, a balanced type of antenna and an unbalanced type of antenna.

To be more specific, a coupling of both switching elements 21, 22 to corresponding inductor elements 17, 18 will couple antenna elements 15 and 16 together via inductor element 17 as well as couple output path 19 to ground plate 14 via inductor element 18. Two antenna elements 15, 16 thus form a balanced type of antenna having a balun as feeder section 24 formed of inductor elements 17, 18.

On the other hand, a coupling of both switching elements 21, 22 to bypass conductor 20 will allow antenna 15 to be coupled to output path 19 via bypass conductor 20. Antenna element 16 and inductor elements 17, 18 are isolated from the line between antenna 15 and output path 19, so that they become elements as no fed. Thus an unbalanced type of antenna can be formed by coupling an end of antenna element 15 to ground plate 14 via feeder section 25.

Antenna elements 15, 16 are placed in parallel with a short side of rectangle-like ground plate 14. Electrical length θ of antenna elements 15, 16 is set corresponding to ¼ of wavelength λ₁ which corresponds to a fundamental frequency established in response to a radio system to be used. In this case, the fundamental frequency is 620 MHz, so that wavelength λ₁ is approx. 484 mm, electrical length θ is a quarter of the wavelength, i.e. approx. 121 mm. Antenna elements 15, 16 take a form of helical shape or meander shape, in other words, physical length L1 (24 mm) of antenna element 15 is shorter than electrical length θ (approx. 121 mm) of antenna elements 15, 16. In this embodiment, antenna element 16 has a physical length L2=24 mm identical to that of element 15.

The antenna device in accordance with this embodiment can use a frequency of 770 MHz as the maximum frequency in the usable frequency band, so that wavelength λ2 is approx. 390 mm, and a quarter of wavelength λ₂ is approx. 97 mm. Assume that ground plate 14 has a short side of which length “a” is 50 mm and a long side of which length “b” is 90 mm. The dimensions of ground plate 14 are set this way: the short side length “a” (50 mm) is greater than the sum of physical lengths L1 and L2 (L1+L2=48 mm), and a half of the short side length (a/2=25 mm) is smaller than ¼ wavelength λ₂ (approx. 97 mm). The foregoing conditions are expressed in the following formulas:

θ=λ₁/4, L1<θ, (L1+L2)≦a, a/2<λ₂/4

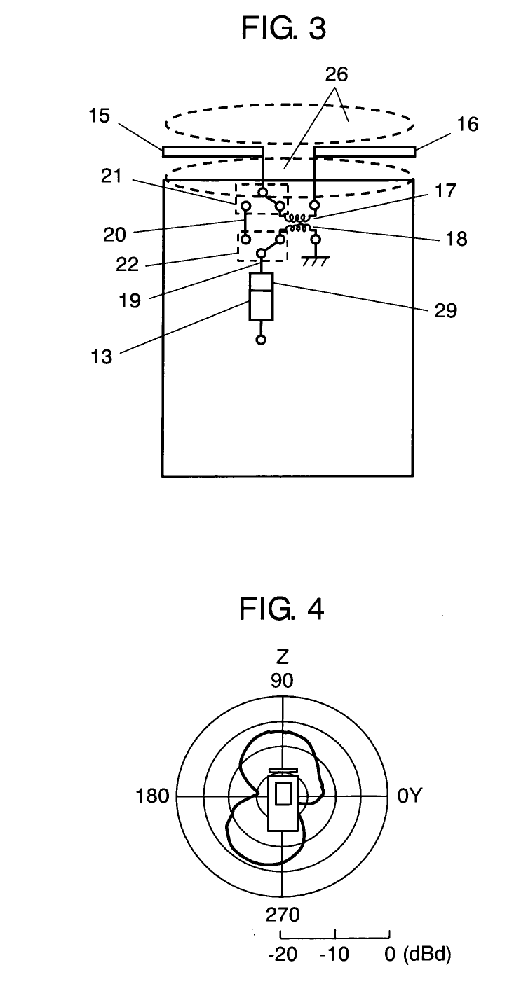

When the constrains discussed above are imposed on the foregoing antenna device, the balanced type of antenna formed of antenna elements 15, 16 has a radiation characteristic as shown in FIGS. 3, 4. The characteristic has radiating area 26 generally vertical with respect to an extending direction of antenna elements 15, 16. FIG. 3 illustrates an operating status when the antenna device of this embodiment is used as the balanced type of antenna. FIG. 4 shows a directivity characteristic of the balanced type of antenna shown in FIG. 3.

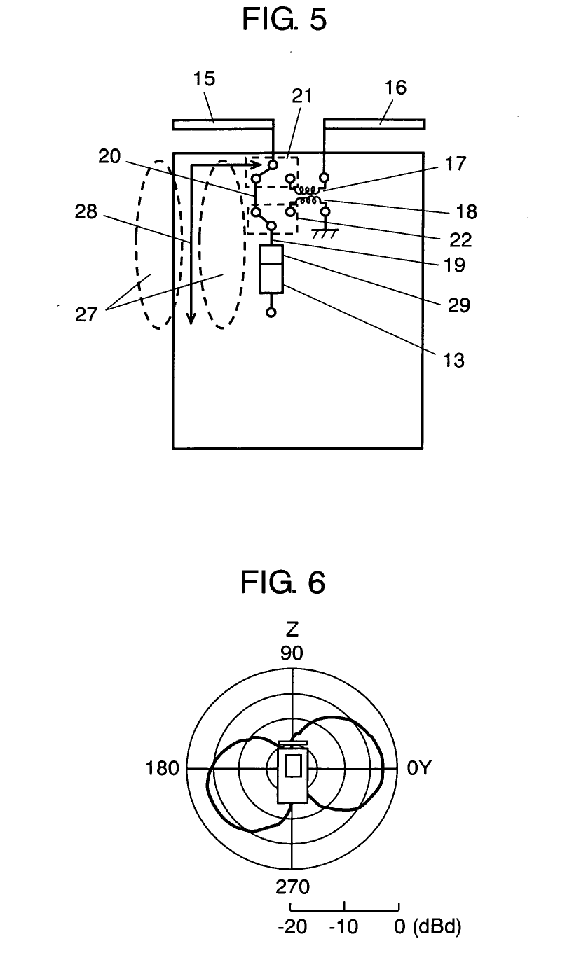

When the unbalanced type of antenna is formed using antenna element 15, radiating area 27 appears generally in the extending direction of antenna element 15 as shown in FIGS. 5, 6. FIG. 5 illustrates an operating status when the antenna device of this embodiment is used as the unbalanced type of antenna. FIG. 6 shows a directivity characteristic of the unbalanced type of antenna shown in FIG. 5.

The mechanism of appearing radiating-area 27 along the extending direction of antenna element 15 of the unbalanced type of antenna is detailed hereinafter. In this embodiment, as an operation of the unbalanced antenna, antenna element 15 does not directly receive radio-wave but ground plate 14 receives the radio-wave, and electric current 28 excited by the reception signal resonates the unbalanced antenna including antenna element 15.

In the area where antenna element 15 is placed confronting to ground plate 14, a phase of the electric current running on element 15 is reversal to a phase of the electric current running on plate 14, so that the radiation characteristic is difficult to appear in this area. Thus physical length L1 of antenna element 15 is set shorter than electrical length θ for securing a non-confronting area between element 15 and plate 14 on ground place 14 at the area where excitation current 28 is available.

A half length (a/2) of the short side of ground plate 14 is set to be smaller than a quarter of wavelength λ₂ corresponding to the max. frequency of the frequency band used by the radio system. Based on this structure, when antenna element 15 is placed along the short side of ground plate 14, the distance between feeder section 25 and the long side, nearer to feeder section 25, of ground plate 14 becomes shorter than a quarter of the wavelength of any frequency of the frequency band to be used.

At any frequency of the frequency band to be used, the area not-confronting to antenna element 15, which area has the radiation characteristic discussed previously, is extended and widened up to the long side. The long side of ground plate 14 is thus exited, so that the radiation characteristic is formed along the extending direction of antenna element 15.

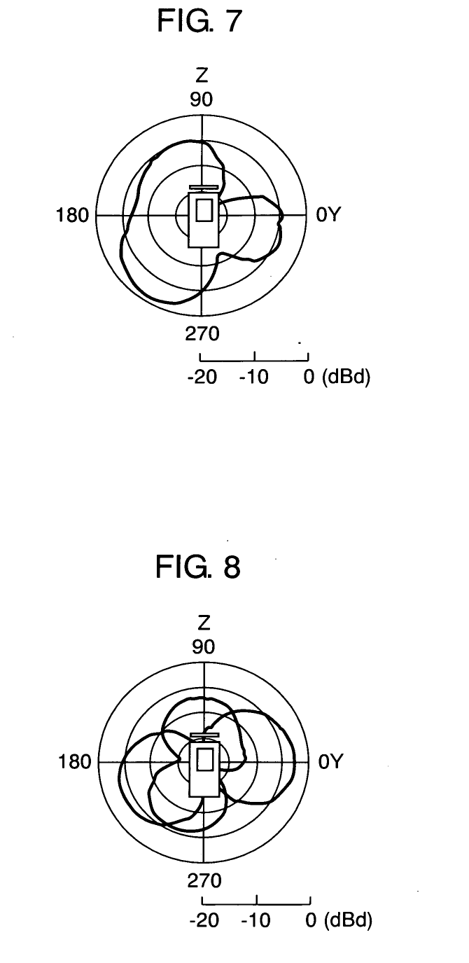

Antenna element 15 not in accordance with this embodiment has physical length L1 which is similar to electrical length θ, namely, 120 mm, and assume that this antenna element is used as an unbalanced type of antenna. FIG. 7 shows a directivity characteristic of an unbalanced type of antenna which has the antenna element longer than the short side of the ground plate as shown in FIG. 5. In this antenna, antenna element 16 has a physical length L2=120 mm. A half of the short side length “a” is 25 mm, so that antenna element 15 sticks out by approx. 95 mm from the ground plate. In this dimensional relation, the radiation characteristic cannot appear along the extending direction of antenna element 15, thus the characteristic expressed with letter “8” cannot be obtained as shown in FIG. 7.

On top of that, the mobile radio apparatus of this embodiment sometime does not like such a structure as antenna elements 15, 16 solely stick out from other parts. It is thus preferable to make the sum of physical lengths L1, L2 (L1+L2) of antenna elements 15, 16 shorter than the short side length “a”, where elements 15, 16 are placed on one straight line and in parallel with the short side of ground plate 14. Considering the radiation characteristic of the antenna device, it is preferable to set the physical lengths L1, L2 of antenna elements 15, 16 and short side length “a” of ground plate 14 at the same time.

The balanced type of antenna and the unbalanced type of antenna discussed previously allow forming a directivity characteristic expressed in two letters of “8” orthogonal to each other as shown in FIG. 8, and switching circuit 23 appropriately switches the two letters of “8”, thereby effectively reducing the directivity of the radiation characteristic of the antenna device. The mobile radio device thus can obtain stable receiving sensitivity free from changes in orientation depending on its receiving status. FIG. 8 superimposes each one of the directivity characteristics shown in FIGS. 4 and 6.

Next, the switch control of switching elements 21, 22 is demonstrated hereinafter. As shown in FIG. 2, signal detector 29 is coupled to output path 19. Detector 29 judges a status of a reception signal supplied from output path 19, and based on the judging result, detector 29 outputs switch controlling signal 30, which controls on-off of switching elements 21 and 22, thereby controlling switching circuit 23. Then antenna elements 15, 16 are selected to be used in which type of antenna, and the directivity of the antenna device is determined. As a result, a stable reception level of TV signals can be maintained.

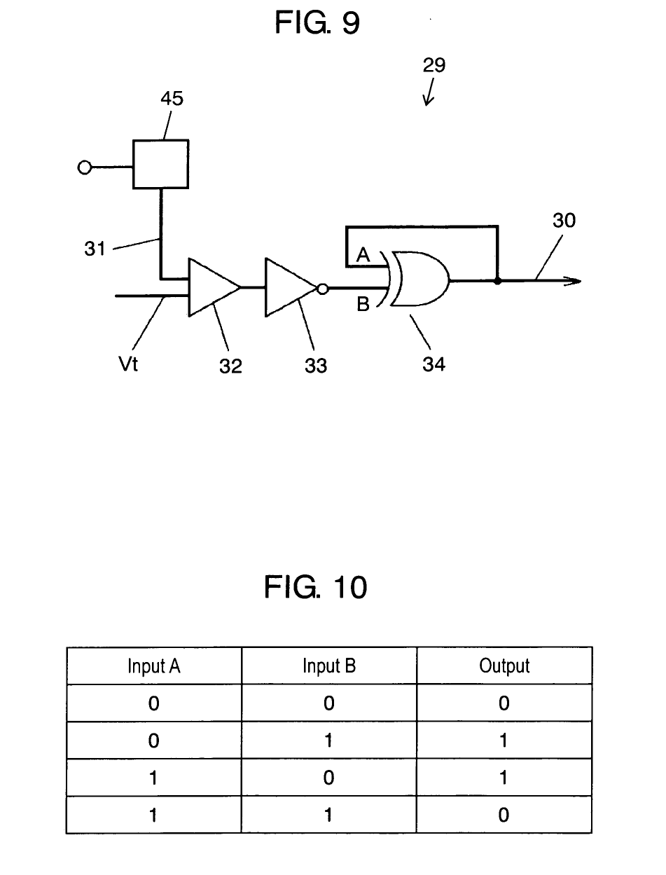

Switch controlling signal 30 using a detection signal obtained from signal detector 29 can be formed through a hardware-oriented process using components mounted, or a software-oriented process using microprocessors, or a process mixing those two processes. FIG. 9 shows a block diagram illustrating an operation of a switch controlling signal, formed through the hardware-oriented process, of the antenna device in accordance with this embodiment. In FIG. 9, the signal detector comprises level detector 45, comparator 32, NOT operator 33, and Ex-OR operator 34.

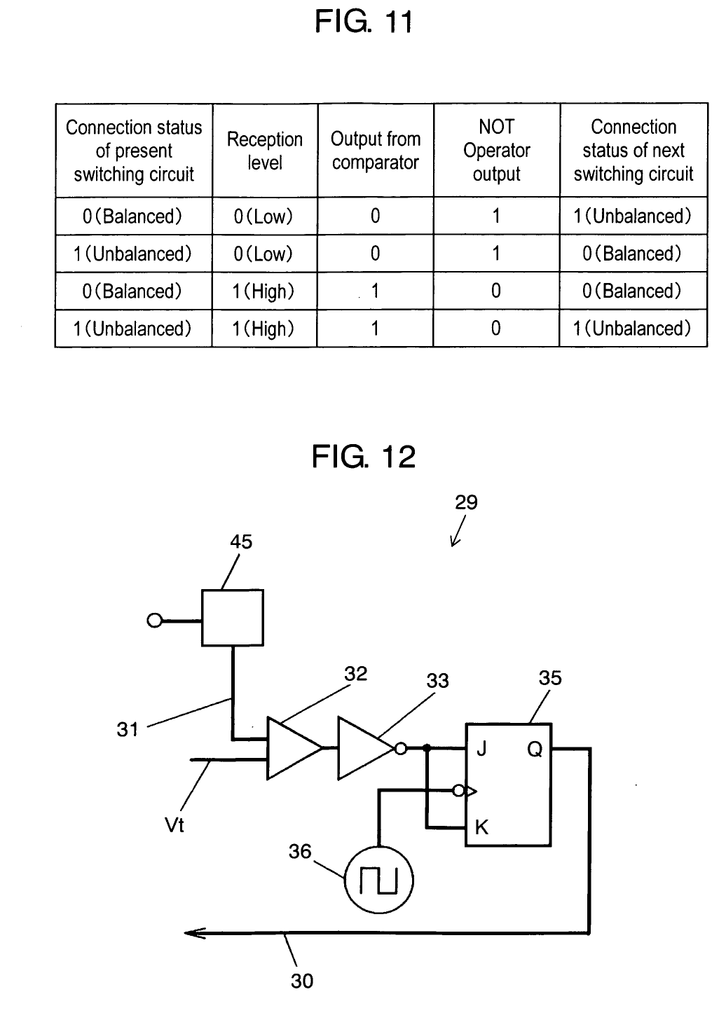

Level detector 45 detects a signal level of a reception signal supplied from output path 19. Comparator 32 compares a voltage of detection signal 31 detected by level detector 45 with reference voltage “Vt”. NOT operator 33 reversely processes the comparison result obtained in comparator 32. As shown in FIGS. 10, 11, Ex-OR operator 34 forms switch controlling signal 30 that switches a connecting status of switching circuit 23 only when the reception level is low. FIG. 10 shows an operation of Ex-OR operator 34 in accordance with this embodiment, and FIG. 11 shows a switch controlling operation in accordance with this embodiment.

FIG. 12 shows a block diagram illustrating an operation of another switch controlling signal, formed through the hardware-oriented process, of the antenna device in accordance with this embodiment. Elements similar to those in FIG. 9 have the same reference marks and the descriptions thereof are omitted here. In FIG. 12, the signal detector comprises level detector 45, comparator 32, NOT operator 33, JK flip-flop 35, and pulse oscillator 36.

JK flip-flop 35 feeds an output from NO operator 33 into two input ports J and K, and as shown in FIG. 13, when “0” (zero) is fed into both of ports J and F, flip-flop 35 maintains an output status, and when “1” (one) is fed into the ports, flip-flop 35 reverses an output status. Pulse oscillator 36 oscillates pulses which control an operation timing of JK flip-flop 35. FIG. 13 shows an operation of JK flip-flop 35 in accordance with this embodiment.

The signal detector shown in FIG. 12 carries out the switch controlling as shown in FIG. 11, just the same as the signal detector shown in FIG. 9 does. To be more specific, a selected status between balance and unbalance is reversed from the initial status only when the reception level is low. Thus a high reception level can be always maintained. Use of JK flip-flop 35 allows the signal detector shown in FIG. 12 to synchronize an operation timing with a clock pulse obtained by pulse oscillator 36. The clock pulse obtained from oscillator 36 can be set slower than a response speed of detection signal 31, so that a stable switch controlling is achievable.

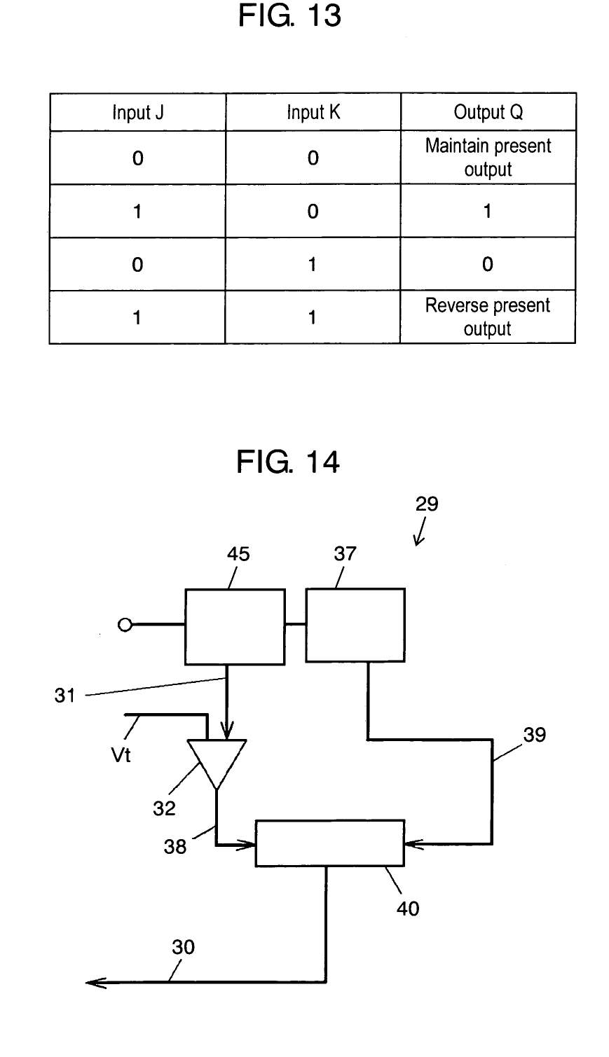

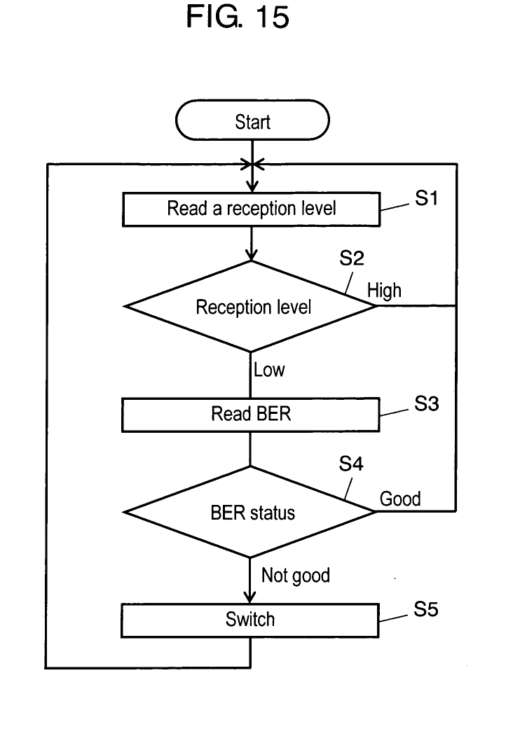

FIG. 14 shows a signal detector, employing a software-oriented process, in accordance with this embodiment. Similar elements to those shown in FIG. 9 have the same reference marks, and the descriptions thereof are omitted here. The signal detector comprises level detector 45, comparator 32, demodulator 37, and microprocessor 40. Demodulator 37 demodulates a signal supplied from output path 19, and outputs BER (bit error rate) information 39. Demodulator 37 can be shared with another demodulator (not shown) disposed in tuner block 13. Microprocessor 40 processes reception level information 38 having undergone the comparison done by comparator 32, and also processes BER information 39 supplied from demodulator 37. FIG. 15 shows a flowchart illustrating how microprocessor 40 operates the switch controlling signal.

In the flowchart shown in FIG. 15, first, read reception level information 38 (S1), then determine the status of information 38 (S2). When the reception level is high (S2 high), maintain a coupling status of switching circuit 23 as it is, and read the reception level again (S1). When the reception level is low (S2 low), read BER information 39 (S3).

When BER is in “good” status, namely, BER is low (S4 good), maintain a coupling status of switching circuit 23 as it is, and read the reception level again (S1). When BER is in “not good” status, namely, BER is high (S4 “not good”), change the coupling status of switching circuit 23 (S5). Then return to “read the reception level” (S1). As discussed above, switching of the switching circuit 23 is determined taking two steps, i.e. determined by a reception level information and by BER information, so that useless processes can be eliminated and an appropriate switching can be expected.

In this embodiment, physical length L2 of antenna element 16 is set equal to physical length L1 of antenna element 15; however, the present invention is not limited to this condition, i.e. physical lengths L1, L2 can be different from each other as far as the directivity characteristic of the balanced type of antenna formed by antenna elements 15, 16 can satisfy a given characteristic.

### INDUSTRIAL APPLICABILITY

According to an antenna device of the present invention and a mobile radio apparatus employing the same antenna device, the directivity in the radiation characteristic of the antenna device can be reduced, and the mobile radio apparatus can enhance its convenience. The antenna device is useful for mobile radio apparatuses such as a mobile phone with TV, and the mobile radio apparatus is useful as a mobile phone with TV.

1. An antenna device comprising:
a ground plate shaping like a rectangle;
a first antenna element and a second antenna element disposed in parallel with a short side of the ground plate; and
a switching circuit for selecting one of a balanced type of antenna or an unbalanced of antenna, wherein the balanced type of antenna is formed by coupling the first antenna element to the second antenna element via a first feeder section, and the unbalanced type of antenna is formed by coupling the first antenna element to the ground plate via a second feeder section and leaving the second antenna element as no fed,
wherein the antenna device satisfies formulas below:
θ=λ₁/4, L1<θ, (L1+L2)=a, a/2<λ₂/4
where “a” is a length of the short side of the ground plate, “b” is a length of a long side of the ground plate, λ₁ is a wavelength corresponding to an established fundamental frequency of the first and the second antenna elements, λ₂ is a wavelength corresponding to a maximum frequency in an applied frequency band of the first and the second antenna elements, θ is an electrical length of the first and the second antenna elements, L1 is a physical length of the first antenna element, and L2 is a physical length of the second antenna element.

2. The antenna device of claim 1, wherein when the first and the second antenna elements are used as the balanced type of antenna, the first antenna element is coupled to the second antenna element via a first reactance element of the first feeder section, and a second reactance element is disposed for being coupled with the first reactance element to form the first feeder section, and a signal is supplied from the first feeder section,
wherein when the first antenna element is used as the unbalanced type of antenna, the first reactance element and the second reactance element are separated from the first antenna element, and the first antenna element is coupled to the ground plate via the second feeder section, and a signal is supplied from the second feeder section.

3. The antenna device of claim 2, wherein a bypass conductor is disposed to between an end of the first antenna element to which end the first reactance element is coupled and an end of the second reactance element from which end a signal is supplied, wherein the switching circuit is formed of a first switching element, which selectively couples one of the first reactance element or the bypass conductor to the end of the first antenna element, and a second switching element, which selectively couples one of the second reactance element or the bypass conductor to an output path to which a signal from the second reactance element is supplied.

4. The antenna device of claim 1 further comprising a signal detector for detecting a signal supplied from one of the balanced type of antenna or the unbalanced type of antenna, wherein the switching circuit is operated based on a detection done by the signal detector.

5. A mobile radio apparatus comprising:
a first antenna device defined as the antenna device in claim 1;
a first signal processor for receiving or outputting a signal from or to the first antenna device;
a second antenna device of which usable frequency band is different from that of the first antenna device; and
a second signal processor for receiving or outputting a signal from or to the second antenna device.

6. A mobile radio apparatus comprising:
a first antenna device defined as the antenna device in claim 2;
a first signal processor for receiving or outputting a signal from or to the first antenna device;
a second antenna device of which usable frequency band is different from that of the first antenna device; and
a second signal processor for receiving or outputting a signal from or to the second antenna device.

7. A mobile radio apparatus comprising:
a first antenna device defined as the antenna device in claim 3;
a first signal processor for receiving or outputting a signal from or to the first antenna device;
a second antenna device of which usable frequency band is different from that of the first antenna device; and
a second signal processor for receiving or outputting a signal from or to the second antenna device.

8. A mobile radio apparatus comprising:
a first antenna device defined as the antenna device in claim 4;
a first signal processor for receiving or outputting a signal from or to the first antenna device;
a second antenna device of which usable frequency band is different from that of the first antenna device; and
a second signal processor for receiving or outputting a signal from or to the second antenna device.
